(19) United States
(12) Patent Application Publication
(10) Pub. No.: US 2026/0019243 A1
(43) Pub. Date: Jan. 15, 2026

(54) SYSTEMS AND METHODS FOR PERSONALITY AWARE KEY MANAGEMENT

(71) Applicant: Axiado Corporation, San Jose, CA (US)

(72) Inventor: Raghu Kondapalli, San Jose, CA (US)

(21) Appl. No.: 19/266,707

(22) Filed: Jul. 11, 2025

Related U.S. Application Data
(60) Provisional application No. 63/671,364, filed on Jul. 15, 2024.

(51) Int. Cl. H04L 9/08; H04L 9/32

(52) U.S. Cl. CPC H04L 9/0861; H04L 9/0891; H04L 9/3278

(57) ABSTRACT

Described herein are systems and methods for providing device security. The systems and methods provided herein can comprise generating a personality using one or more parameters of the device. The systems and methods provided herein can further comprise deriving a personality root key based at least in part on the personality.

### CROSS-REFERENCE TO RELATED APPLICATIONS

This application claims the benefit of U.S. Provisional Application No. 63/671,364, filed Jul. 15, 2024, which is incorporated by reference herein in its entirety.

### BACKGROUND

Keys (e.g., symmetric keys) can be employed to achieve confidentiality and/or to safeguard privacy of the data. This data may belong to the device, system, owner, tenants, etc. The process of managing these keys may be referred to as “Key Management.” Managing keys may be critical to the security of the device.

### SUMMARY

Provided herein are computer-implemented methods of providing device security comprising: (a) generating a unique personality for the device using parameters comprising one or more of: device lifecycle stage, device debug state, device ownership, device operating environment, and user credentials; (b) maintaining a data access matrix associating the personality with a subset of data stored in the device; (c) deriving a unique personality root key by cryptographically combining the personality with a physically unclonable function root key; (d) encrypting the subset of the data associated with the personality using the personality root key; and (e) maintaining an auditable data access log for the personality. In some embodiments, the device comprises a computing device comprising a key management mechanism. In some embodiments, the operating environment comprises one or more of: operating system version, firmware version, device ID, root ID, container ID, virtual machine ID, and session tokens. In some embodiments, the method further comprises generating a plurality of unique personalities for the device. In some embodiments, the plurality of personalities comprises at least one split personality. In some embodiments, the plurality of personalities comprises one or more adjacent personalities, lateral personalities, or hierarchical personalities. In some embodiments, the data access matrix is stored in non-volatile random-access memory. In some embodiments, the non-volatile random-access memory comprises one-time programmable memory. In some embodiments, the data access log for the personality is tamperproof. In some embodiments, the personality root key is derived at device boot. In some embodiments, further comprising deriving the personality root key each time the device is booted into the selected personality to access the subset of the data. In some embodiments, further comprising receiving a data access request from a requesting entity. In some embodiments, further comprising decrypting the requested data using the derived personality root key. In some embodiments, the method further comprises returning the requested data to the requesting entity. In some embodiments, the personality root key is deleted when the device is powered off. In some embodiments, the method further comprises revoking the selected personality rendering the personality root key invalid. In some embodiments, each auditable data access log comprises one or more of: requesting entity, requested data, device personality at time of request, date and time of request, device personality at the time of access, date and time of access.

Further provided herein are computer-implemented systems comprising at least one processor, non-volatile memory, volatile memory, and instructions executable by the at least one processor to cause the at least one processor to perform operations comprising: (a) generating a unique personality for a device using parameters comprising one or more of: device lifecycle stage, device debug state, device ownership, device operating environment, and user credentials; (b) maintaining a data access matrix associating the personality with a subset of data stored in the device; (c) deriving a unique personality root key by cryptographically combining the personality with a physically unclonable function root key; (d) encrypting the subset of the data associated with the personality using the personality root key; and (e) maintaining an auditable data access log for the personality. In some embodiments, the device comprises a computing device comprising a key management mechanism. In some embodiments, the operating environment comprises one or more of: operating system version, firmware version, device ID, root ID, container ID, virtual machine ID, and session tokens. In some embodiments, the system further comprises generating a plurality of unique personalities for the device. In some embodiments, the plurality of personalities comprises at least one split personality. In some embodiments, the plurality of personalities comprises one or more adjacent personalities, lateral personalities, or hierarchical personalities. In some embodiments, the data access matrix is stored in non-volatile random-access memory. In some embodiments, the non-volatile random-access memory comprises one-time programmable memory. In some embodiments, the data access log for the personality is tamperproof. In some embodiments, the personality root key is derived at device boot. In some embodiments, the system further comprises deriving the personality root key each time the device is booted into the selected personality to access the subset of the data. In some embodiments, the system further comprises receiving a data access request from a requesting entity. In some embodiments, the system further comprises decrypting the requested data using the derived personality root key. In some embodiments, the system further comprises returning the requested data to the requesting entity. In some embodiments, the personality root key is deleted when the device is powered off. In some embodiments, the system further comprises revoking the selected personality rendering the personality root key invalid.

Further provided herein are non-transitory computer-readable storage media encoded with instructions executable by one or more processors to provide an application configured to perform operations comprising: generating a unique personality for a device using parameters comprising one or more of: device lifecycle stage, device debug state, device ownership, device operating environment, and user credentials; maintaining a data access matrix associating the personality with a subset of data stored in the device; deriving a unique personality root key by cryptographically combining the personality with a physically unclonable function root key; encrypting the subset of the data associated with the personality using the personality root key; and maintaining an auditable data access log for the personality. In some embodiments, the device comprises a computing device comprising a key management mechanism. In some embodiments, the operating environment comprises one or more of: operating system version, firmware version, device ID, root ID, container ID, virtual machine ID, and session tokens. In some embodiments, the system further comprises generating a plurality of unique personalities for the device. In some embodiments, the plurality of personalities comprises at least one split personality. In some embodiments, the plurality of personalities comprises one or more adjacent personalities, lateral personalities, or hierarchical personalities. In some embodiments, the data access matrix is stored in non-volatile random-access memory. In some embodiments, the non-volatile random-access memory comprises one-time programmable memory. In some embodiments, the data access log for the personality is tamperproof. In some embodiments, the personality root key is derived at device boot. In some embodiments, the system further comprises deriving the personality root key each time the device is booted into the selected personality to access the subset of the data. In some embodiments, the system further comprises receiving a data access request from a requesting entity. In some embodiments, the system further comprises decrypting the requested data using the derived personality root key. In some embodiments, the system further comprises returning the requested data to the requesting entity. In some embodiments, the personality root key is deleted when the device is powered off. In some embodiments, the system further comprises revoking the selected personality rendering the personality root key invalid.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a schematic for generating a personality root key on a device, according to some embodiments;

FIG. 2 shows a non-limiting example of the life cycle of a personality root key, according to some embodiments;

FIG. 3 shows a non-limiting example of a method for providing device security using a personality root key, according to some embodiments; and

FIG. 4 shows a non-limiting example of a computing device; in this case, a device with one or more processors, memory, storage, and a network interface, according to some embodiments.

### DETAILED DESCRIPTION

A device may generally support one or more personalities. A personality of a device may generally comprise data or a combination of data associated with the device. A personality may comprise a unique combination of data associated with the device, such that each personality of a device is different from other personalities. In some embodiments, the personality of the device may be determined by a combination of data that is not confidential, but requires security properties such as integrity and availability.

In a given boot, the device may have only one personality. In some embodiments, the device has one personality in a given boot to maintain the confidentiality and/or privacy of the personality's data. As such, in some embodiments, the personality of a device ascertains its behavior. In some embodiments, the personality of a device also controls what features and services are supported. In some instances, the personality is also referred to as realm. In some examples, a device debug personality cannot decrypt data belonging to the user when the device is in production state.

A Physically Unclonable Function (PUF) output may be referred to as “PUF Root Key” (PUFRK). A PUF generally refers to an object whose operation generates results unique to a given processing chip containing the PUF. For example, a PUF may generate results that are highly dependent on the given processing chip containing the PUF and/or on the current environmental conditions in which the given processing chip is operated, such as, by way of non-limiting example, generating Process-sensitive, Voltage-sensitive, and/or Temperature-sensitive (PVT-sensitive) results. For example, a ring oscillator is generally PVT-sensitive, and sampling a long ring oscillator at a stable clock frequency produces PVT-sensitive results that are random and unpredictable. More complicated PUFs can also be contemplated. For example, a more complicated PUF may use multiple ring oscillators (at different nominal frequencies) and combine their results, and/or use other techniques, such as results dependent on transistor threshold variations. In some embodiments, systems and methods of the present disclosure can be generally agnostic to a type of PUF used. In some embodiments, it may be advantageous to use a particular type of PUF for reasons of performance, efficiency, compatibility with security standards, or other factors.

The PUF output may be random, unique, or both. In some embodiments, the PUFRK is never stored on-chip, off-chip, or both when the device is powered off. However, in some embodiments, a Physically Unclonable Function (PUF) can deterministically and securely re-construct the PUFRK. This may be the case when the same device is powered on using some underlying properties of randomness, such as SRAM or similar device that provides a unique, random, yet a noisy fingerprint and Activation Code (AC) that is obtained during PUF enrollment. In some embodiments, the PUFRK may be the same for a given device irrespective of device personalities. In some embodiments, the PUFRK may be different for each of at least two personalities on a given device.

Using one PUFRK for all personalities may result in accidental usage of the keys to decrypt the data or disclosure of the data. Generally, current architectures may not allow disclosure of the PUFRK but it can be used. Again, using a single root key for all personalities may not be robust in cases of attacks. An attack may include, by way of non-limiting example, an attack by a compromised firmware, software, or both, or via insider attacks when the device is in a debug state. Thus, in some embodiments, the systems and methods provided herein limit the data availability to a given personality for which the data belongs and ensures the current device personality cannot access data belonging to a different personality.

In some cases, the device ownership is a parameter in determining the personality of the device. The device ownership, in some instances, can be relinquished or revoked. In such cases, the data belonging to the relinquished or revoked personalities may be permanently lost or never recovered. Further, there may be challenges in maintaining data access records for compliance and audit purposes for a personality. This may be true when there are multiple personalities. Generally, current systems lack this capability. Thus, there is a need to easily audit these systems for protected data within the device.

Provided herein are system and methods for preventing data disclosures and data breaches. Data disclosures or breaches may occur because of device compromises, such as the attacks provided herein. In such instances, limiting the damage may be a significant challenge when a device supports more than one personality. The systems and methods provided herein may solve this problem by addressing a root cause in key management where the personalities are tightly coupled to deriving the respective unique personality keys. Key Management may generally refer to a blanket term used to define and implement functions that include but not limited to key generation, key usage, secure key storage (off-chip/on-chip), secure key erase or destruction, etc.

The systems and methods provided herein comprise encrypting data with a unique key. Since the data is encrypted with this unique key, it may not be possible to derive a key that does not belong to a current personality. In such instances, the data belonging to another personality is protected even though there is a breach within the device with the current personality. The derived keys may further dictate on the key usage, storage, key erase, etc. Tying a device personality to the key management can, in some instances, enhance the security of the device. In some instances, it enhances security by protecting against accidental exposure of data. In some instances, it provides one or more security advantages. In some examples, an advantage comprises data isolation. In some examples, an advantage comprises the ability to permanently delete the data when the personality has been relinquished or revoked because of security compromises.

Provided herein is a method of providing device security. A device as provided herein may generally comprise a computing device that has a built in key management mechanism. In some embodiments, the method comprises one or more of: (i) generating one or more personalities of a device; (ii) coupling a device personality to a PUFRK using one or more properties of the PUF IP; (iii) providing a data access matrix; (iv) providing data access logs per persona; or any combination thereof. In some instances, providing a data access matrix allows a device persona to access data within the device. In some instances, the data access logs per persona is maintained on the device hardware. This can ensure, in some instances, that the logs are tamper proof.

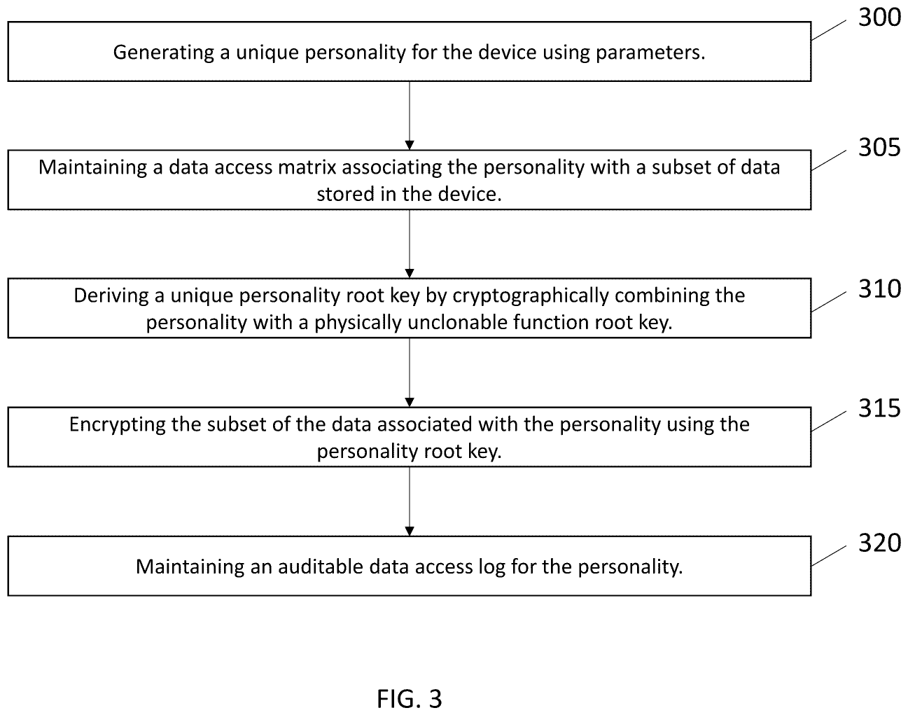

An exemplary method for providing device security is provided in FIG. 3. A method for providing device security may comprise one or all of the operations provided herein. In some embodiments, the method comprises generating a device personality. Generating a device personality may comprise generating a unique personality for the device using one or more parameters 300, as further described herein. In some embodiments, the method comprises maintaining a data access matrix. The data access matrix may be associating the personality with at least a subset of data stored in the device 305, as further described herein. In some embodiments, the method comprises deriving a unique personality root key. The unique personality root key may be derived by cryptographically combining the personality with a physically unclonable function root key 310, as further described herein. In some embodiments, the method comprises encrypting the subset of the data associated with the personality. The encrypting may be done using the personality root key 315, as further described herein. In some embodiments, the method comprises maintaining an auditable data access log for the personality 320, as further described herein.

The method can comprise generating a unique personality for the device using one or more parameters. The method may be applied to some or all personalities accessing the device. A personality can generally be associated to a hardware, firmware, software or any combination thereof. In some embodiments, the personality belongs to a container, virtualized machine, guest OS, or user login. In some instances, the data is protected beyond the device. If the data is protected beyond the device, the data can only be retrieved on that device and with a given personality. In such instances, the same personality on a different device cannot retrieve the data.

In some embodiments, a personality does not have confidential requirements. In some embodiments, a personality only has public information. In some embodiments, security stems from the fact that a personality or context cannot be spoofed in a given boot. In some embodiments, more than one personality cannot exist at the same time which have a similar scope or privileges (e.g., scope of access to data on a given device). In some embodiments, the spoofing protections comes from hardware, firmware, software, or any combination thereof.

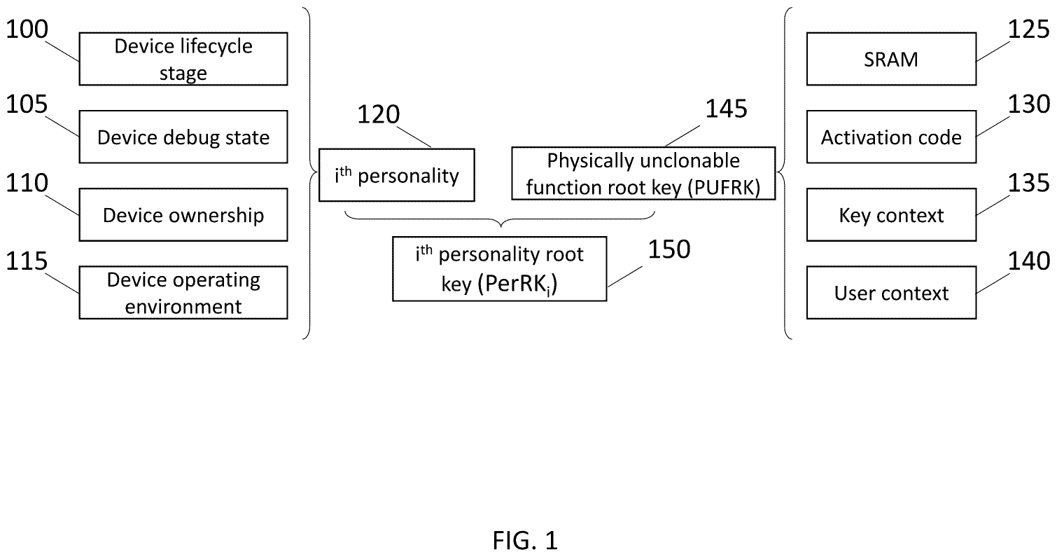

In some embodiments, a personality of a device is generated using one or more parameters. One or more exemplary parameters for generating a personality is provided for example in FIG. 1. As shown, the one or more parameters for generating a given personality 120 may comprise the device lifecycle storage 100, device debug state 105, device ownership 110, or device operating environment 115. In some instances, the one or more parameters comprise device lifecycle stage, device debug state, device ownership, device operating environment, user credentials, or any combination thereof. In some cases, the operating environment 115 comprises operating system version, firmware version, device ID, root ID, container ID, virtual machine ID, session tokens, or any combination thereof. A session token may comprise, in some examples, a onetime ephemeral token generated on the fly that is valid for a given session. In some instances, a personality does not comprise personal information. The properties of the one or more parameters, such as the size, encoding, or format may vary based on the implementation or embodiment of the systems and methods provided herein. However, a given combination of the one or more parameters associated with a device can produce a unique discernable personality, which is the key.

In some embodiments, the method comprises generating a plurality of unique personalities for the device. As shown in FIG. 1, for a given device, an i^{th} personality may be generated, where i is an integer between 1 and the total number of personalities N associated with a given device. In some cases, N comprises 1, 2, 3, 4, 5, 6, 7, 8, 9, 10, 12, 15, 18, 20, 25, 30, 40, 50, 60, 70, 80, 90, or 100, including increments therein. In some cases, N comprises at least 1, 2, 3, 4, 5, 6, 7, 8, 9, 10, 12, 15, 18, 20, 25, 30, 40, 50, 60, 70, 80, or 90, including increments therein. In some cases, N comprises no more than 1, 2, 3, 4, 5, 6, 7, 8, 9, 10, 12, 15, 18, 20, 25, 30, 40, 50, 60, 70, 80, 90, or 100, including increments therein. In some cases, N comprises 1-5, 1-10, 1-20, 1-50, 1-100, 2-5, 2-10, 3-5, 3-10, 4-8, 4-10, 4-15, 5, 10, 5-15, 5-20, 5-25, 10-15, 10-20, 10-30, 10-50, 15-25, 20-30, 20-50, 30-40, 30-60, 40-50, 40-70, 50-80, 60-90, or 70-100.

In some instances, the plurality of personalities comprises at least one split personality. In some instances, the plurality of personalities comprises one or more adjacent personalities, lateral personalities, or hierarchical personalities. The operating environment may generally support hierarchical personalities and split personalities. In some examples, the split personalities is adjacent, lateral, or hierarchical. In some examples, a device personality comprises at least one parameter that overlaps with a different device personality. For example, two device personalities can comprise the same device ownership, but other parameters may be different.

In some embodiments, the method comprises maintaining a data access matrix. In some embodiments, personality specific access data matrix can be stored in OTP or any other NVRAM based on implementation needs. In some instances, when a new data access request is made, hardware is expected to check the personality and data access permissions from this matrix. In some instances, only upon successful completion of these checks is the data returned to the requesting entity. In some instances, in addition to access checking, data access logs for critical data are maintained. Logging in to hardware to access to critical data may depend on one or more parameters. In some examples, the one or more parameters to access to critical data comprises the entity accessing it, device personality at the time of access, time of day accessing it, whether or not access matrix check has been completed successfully, or any combination thereof.

The data access matrix may, in some instances, associate the personality with a subset of data stored in the device. In some examples, the data access matrix associates a personality with about 0.1%, 0.5%, 1%, 1.5%, 2%, 2.5%, 5%, 8%, 10%, 15%, 20%, 25%, 30%, 40%, 50%, 60%, 70%, 80%, 90%, or 100% of the data stored in the device, including increments therein. In some examples, the data access matrix associates a personality with at least about 0.1%, 0.5%, 1%, 1.5%, 2%, 2.5%, 5%, 8%, 10%, 15%, 20%, 25%, 30%, 40%, 50%, 60%, 70%, 80%, or 90% of the data stored in the device, including increments therein. In some examples, the data access matrix associates a personality with no more than about 0.5%, 1%, 1.5%, 2%, 2.5%, 5%, 8%, 10%, 15%, 20%, 25%, 30%, 40%, 50%, 60%, 70%, 80%, 90%, or 100% of the data stored in the device, including increments therein. In some examples, the data access matrix associates a personality with about 0.1-0.5%, 0.1-1%, 0.1-10%, 0.5-1%, 0.5-2%, 0.5-5%, 1-2%, 1-5%, 1-10%, 2-5%, 2-10%, 5-10%, 5-15%, 5-20%, 5-30%, 10-20%, 10-30%, 20-40%, 20-50%, 20-80%, 30-50%, 30-80%, 40-50%, 40-60%, 50-80%, 60-80%, 70-90%, 80-100%, or 90-100% of the data stored in the device. In some instances, the data access matrix is stored in non-volatile random-access memory. In some cases, the non-volatile random-access memory comprises a one-time programmable memory.

In some embodiments, the method comprises deriving a unique personality root key (PerRK) by cryptographically combining the personality with a physically unclonable function root key (PUFRK). A PUFRK may be generated using the randomness of one or more variables. The one or more exemplary variables for generating a PUFRK 145 is provided for example in FIG. 1. As shown, the one or more variables for generating a given PUFRK 145 may comprise static random-access memory (SRAM) 125, activation code 130, key context 135, user context 140, or any combination thereof. In some instances, the user context comprises one or both of: (i) one or more registers that restricts user context (e.g., restrict_user_context0 and restrict_user_context1); and (ii) user key context data that the firmware sends to the PUF during re-construction phase.

A combination of generating a personality and coupling the personality to the PUFRK using properties of PUF IP can produce a secure, unique, random key. This key may be referred to as personality root key (PerRK) that can deterministically be generated every time the device has been booted with that personality. PerRK may be referred to an outcome of the device establishing a certain personality. Once a personality is established, in some embodiments, it cannot change or be spoofed within or outside of the device for that boot or with that context. Once a PerRK is established, it may be used to derive one or more subsequent keys.

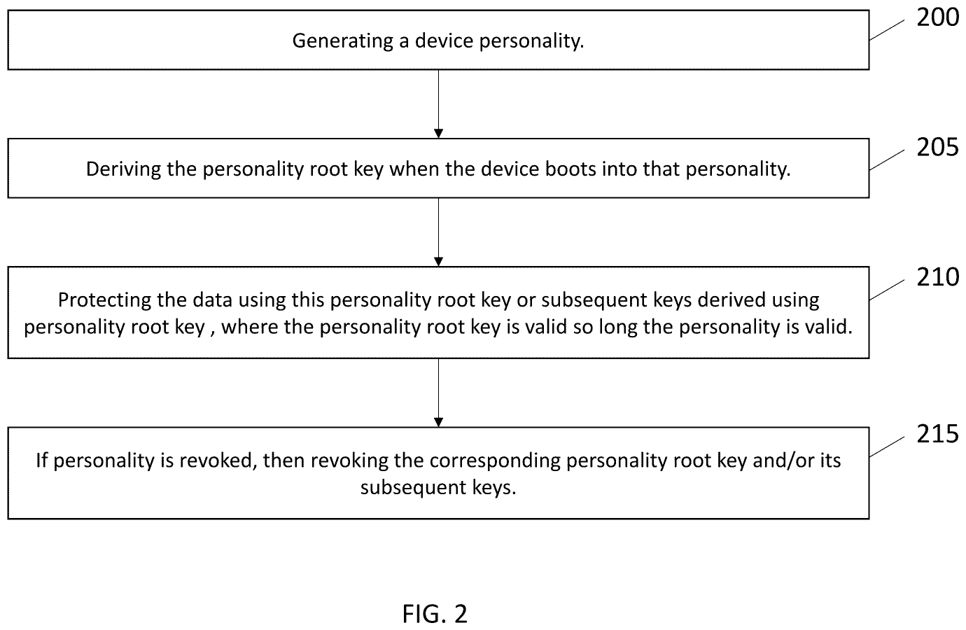

An exemplary life cycle of a PerRK is provided in FIG. 2. In some instances, the life cycle comprises generating a device personality 200, using systems and methods provided herein. The device personality may comprise a unique combination of one or more parameters provided herein. In some instances, the personality root key is derived when the device boots 205, as described herein. In some instances, the data or subset of data on the device is protected using this personality root key 210, or one or more subsequent keys derived using the personality root key 210. The data or subset of data may be protected using the personality root key or one or more subsequent keys so long as the key is valid.

If personality is revoked, then the corresponding personality root key and/or its subsequent keys may also be revoked 215. A revocation of the personality may be rooted in hardware, such as a One-time programmable (OTP) fuse. In some instances, if a personality is revoked or relinquished, that personality can never be reproduced or regenerated on the same device (and hence the PerRK). In such instances, all data that is protected with a PerRK is permanently lost. In such instances, the hardware prevents this revoked personality to be established or used for that device's life time. In some instances, the security relies on the ability to generate this personality uniquely and reliably. In some instances, spoofing a personality is difficult as the personality boot strapping parameters can be tied into the hardware.

A personality root key may be derived at device boot. In some embodiments, the method further comprises deriving the personality root key each time the device is booted into the selected personality to access the subset of the data. In some embodiments, an i^{th} personality generates an i^{th} personality root key (PerRKᵢ). The plain-text data (Plain-Dataᵢ) is encrypted, resulting in cipher-text data (Enc-Dataᵢ). To generate a given personality root key (PerRKᵢ), in some embodiments, some or all of the parameters for generating the PUFRK are used. To generate a given personality root key (PerRKᵢ), in some embodiments, some or all of the parameters for generating the personality are used. The values in registers restrict_user_context0 and restrict_user_context1 may be driven by the personalities. In some embodiments, writes to these registers are protected, access controlled, or a combination thereof. In some instances, this can prevent not only modifications but also prevent personality rollbacks if a personality has been revoked. In some embodiments, some personalities are driven by firmware parameters. For example, a combination of hardware, firmware and software parameters can determine a device's hierarchical or split personalities.

In some embodiments, the method comprises encrypting data associated with the personality using the personality root key. In some instances, the data is encrypted using an encryption algorithm. The encryption algorithm can comprise, by way of non-limiting example, AES, RSA, 3DES, or elliptic curve cryptography.

The data encrypted by a personality root key may be decoded. In some embodiments, decoding of the personality parameters to the user context may not be restricted to a particular schema. In some embodiments, a schema for decoding data encrypted by a personality root key comprises one or more properties. In some instances, a property is that a unique combination of parameters for a given personality always result in a unique user context. In some instances, a property is that a user context is controlled by the hardware, while the firmware's responsibility is only to interface with physically unclonable function (PUF) to ensure its successful operation. In some instances, a property is that for a revoked or relinquished personality via parameters mentioned above, the user context is not reproducible in hardware and the firmware cannot influence it. In some instances, a property is that roll-back attacks that are conducted by reproducing the parameters are impossible.

In some embodiments, the method comprises maintaining an auditable data access log for the personality. In some instances, the data access log for the personality is tamperproof. In some embodiments, the method further comprises receiving a data access request from a requesting entity. In some instances, receiving the data access request comprises decrypting the requested data using the derived personality root key. In some instances, receiving the data access request comprises returning the requested data to the requesting entity. In some embodiments, each auditable data access log comprises one or more of: requesting entity, requested data, device personality at time of request, date and time of request, device personality at the time of access, or date and time of access. In some embodiments, the personality root key is deleted when a device loses power (e.g., powered off). In some embodiments, the method further comprises revoking a selected personality, rendering the personality root key invalid.

In some embodiments, the systems and methods provided herein do not restrict how the one or more personality parameters are generated, provisioned, determined, injected, or where they are stored. By way of non-limiting example, the generation of the parameters can be injected, autonomously generated, generated through policies or via explicit or implicit APIs. In some embodiments, the personality parameters must be stored in non-volatile memory, such as One Time Programmable Memory (OTP) or flash, or a combination thereof.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing System

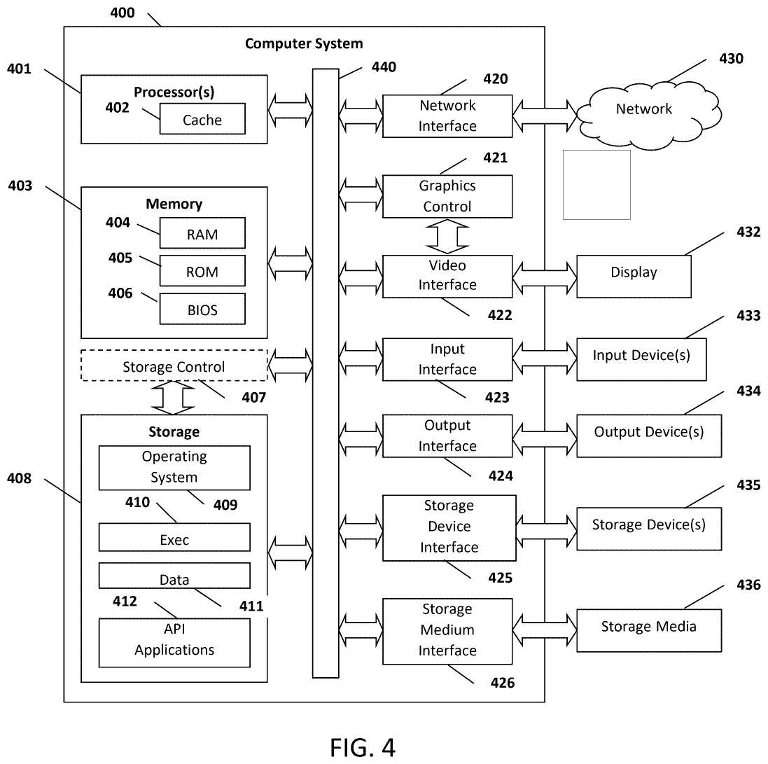

Referring to FIG. 4, a block diagram is shown depicting an exemplary machine that includes a computer system 400 (e.g., a processing or computing system) within which a set of instructions can execute for causing a device to perform or execute any one or more of the aspects and/or methodologies for static code scheduling of the present disclosure. The components in FIG. 4 are examples only and do not limit the scope of use or functionality of any hardware, software, embedded logic component, or a combination of two or more such components implementing particular embodiments.

Computer system 400 may include one or more processors 401, a memory 403, and a storage 408 that communicate with each other, and with other components, via a bus 440. The bus 440 may also link a display 432, one or more input devices 433 (which may, for example, include a keypad, a keyboard, a mouse, a stylus, etc.), one or more output devices 434, one or more storage devices 435, and various tangible storage media 436. All of these elements may interface directly or via one or more interfaces or adaptors to the bus 440. For instance, the various tangible storage media 436 can interface with the bus 440 via storage medium interface 426. Computer system 400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 400 includes one or more processor(s) 401 (e.g., central processing units (CPUs), general purpose graphics processing units (GPGPUs), or quantum processing units (QPUs)) that carry out functions. Processor(s) 401 optionally contains a cache memory unit 402 for temporary local storage of instructions, data, or computer addresses. Processor(s) 401 are configured to assist in execution of computer readable instructions. Computer system 400 may provide functionality for the components depicted in FIG. 4 as a result of the processor(s) 401 executing non-transitory, processor-executable instructions embodied in one or more tangible computer-readable storage media, such as memory 403, storage 408, storage devices 435, and/or storage medium 436. The computer-readable media may store software that implements particular embodiments, and processor(s) 401 may execute the software. Memory 403 may read the software from one or more other computer-readable media (such as mass storage device(s) 435, 436) or from one or more other sources through a suitable interface, such as network interface 420. The software may cause processor(s) 401 to carry out one or more processes or one or more steps of one or more processes described or illustrated herein. Carrying out such processes or steps may include defining data structures stored in memory 403 and modifying the data structures as directed by the software.

The memory 403 may include various components (e.g., machine readable media) including, but not limited to, a random access memory component (e.g., RAM 404) (e.g., static RAM (SRAM), dynamic RAM (DRAM), ferroelectric random access memory (FRAM), phase-change random access memory (PRAM), etc.), a read-only memory component (e.g., ROM 405), and any combinations thereof. ROM 405 may act to communicate data and instructions unidirectionally to processor(s) 401, and RAM 404 may act to communicate data and instructions bidirectionally with processor(s) 401. ROM 405 and RAM 404 may include any suitable tangible computer-readable media described below. In one example, a basic input/output system 406 (BIOS), including basic routines that help to transfer information between elements within computer system 400, such as during start-up, may be stored in the memory 403.

Fixed storage 408 is connected bidirectionally to processor(s) 401, optionally through storage control unit 407. Fixed storage 408 provides additional data storage capacity and may also include any suitable tangible computer-readable media described herein. Storage 408 may be used to store operating system 409, executable(s) 410, data 411, applications 412 (application programs), and the like. Storage 408 can also include an optical disk drive, a solid-state memory device (e.g., flash-based systems), or a combination of any of the above. Information in storage 408 may, in appropriate cases, be incorporated as virtual memory in memory 403.

In one example, storage device(s) 435 may be removably interfaced with computer system 400 (e.g., via an external port connector (not shown)) via a storage device interface 425. Particularly, storage device(s) 435 and an associated machine-readable medium may provide non-volatile and/or volatile storage of machine-readable instructions, data structures, program modules, and/or other data for the computer system 400. In one example, software may reside, completely or partially, within a machine-readable medium on storage device(s) 435. In another example, software may reside, completely or partially, within processor(s) 401.

Bus 440 connects a wide variety of subsystems. Herein, reference to a bus may encompass one or more digital signal lines serving a common function, where appropriate. Bus 440 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 400 may also include an input device 433. In one example, a user of computer system 400 may enter commands and/or other information into computer system 400 via input device(s) 433. Examples of an input device(s) 433 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 433 may be interfaced to bus 440 via any of a variety of input interfaces 423 (e.g., input interface 423) including, but not limited to, serial, parallel, game port, USB, FIREWIRE, THUNDERBOLT, or any combination of the above.

In particular embodiments, when computer system 400 is connected to network 430, computer system 400 may communicate with other devices, specifically mobile devices and enterprise systems, distributed computing systems, cloud storage systems, cloud computing systems, and the like, connected to network 430. Communications to and from computer system 400 may be sent through network interface 420. For example, network interface 420 may receive incoming communications (such as requests or responses from other devices) in the form of one or more packets (such as Internet Protocol (IP) packets) from network 430, and computer system 400 may store the incoming communications in memory 403 for processing. Computer system 400 may similarly store outgoing communications (such as requests or responses to other devices) in the form of one or more packets in memory 403 and communicated to network 430 from network interface 420. Processor(s) 401 may access these communication packets stored in memory 403 for processing.

Examples of the network interface 420 include, but are not limited to, a network interface card, a modem, and any combination thereof. Examples of a network 430 or network segment 430 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 430, may employ a wired and/or a wireless mode of communication. In general, any network topology may be used.

Information and data can be displayed through a display. Examples of a display 432 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 432 can interface to the processor(s) 401, memory 403, and fixed storage 408, as well as other devices, such as input device(s) 433, via the bus 440. The display 432 is linked to the bus 440 via a video interface 422, and transport of data between the display 432 and the bus 440 can be controlled via the graphics control 421.

In addition to a display 432, computer system 400 may include one or more other peripheral output devices 434 including, but not limited to, an audio speaker, a printer, a storage device, and any combinations thereof. Such peripheral output devices may be connected to the bus 440 via an output interface 424. Examples of an output interface 424 include, but are not limited to, a serial port, a parallel connection, a USB port, a FIREWIRE port, a THUNDERBOLT port, and any combinations thereof.

In addition or as an alternative, computer system 400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, firmware, or any combination thereof.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, netbook computers, netpad computers, handheld computers, Internet appliances, mobile smartphones, and tablet computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD, Linux, Apple Mac OS X Server, Oracle Solaris, Windows Server, and Novell NetWare. Those of skill in the art will recognize that suitable personal computer operating systems include, by way of non-limiting examples, Microsoft Windows, Apple Mac OS X, UNIX, and UNIX-like operating systems such as GNU/Linux. In some embodiments, the operating system is provided by cloud computing.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, by way of examples, assets and information of owners. In various embodiments, suitable databases include, by way of non-limiting examples, relational databases, non-relational databases, object-oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### EXAMPLES

The following illustrative examples are representative of embodiments of the software applications, systems, and methods described herein and are not meant to be limiting in any way.

### Example 1—Generating a Personality Root Key (PerRK)

A device boots into a personality based on certain context. This establishes a personality using one or more parameters, such as device lifecycle stage, device debug state, device ownership, or device operating system, or any combination thereof. A physically unclonable function root key (PUFRK) is generated using properties of a PUF IP. The PUF uses the randomness of one or more parameters, such as SRAM, activation code, key context, user context, or any combination thereof. A unique personality root key is then derived by cryptographically combining the personality with a physically unclonable function root key. Some or all of the data on the device is then protected by encrypting the data associated with the personality using the unique personality root key. The device maintains an auditable data access log for the personality. The personality root key may be valid so long as the personality remains valid and data can be protected using this personality root key.

If the context is lost, for example, the device shut off power, then a personality root key is lost. Further, if the personality is revoked, then the corresponding personality root key is revoked. If the personality root key is revoked, then the data protected by the personality root key is lost and cannot be recovered.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented method of providing device security comprising:
(a) generating a unique personality for the device using parameters comprising one or more of: device lifecycle stage, device debug state, device ownership, device operating environment, and user credentials;
(b) maintaining a data access matrix associating the personality with a subset of data stored in the device;
(c) deriving a unique personality root key by cryptographically combining the personality with a physically unclonable function root key;
(d) encrypting the subset of the data associated with the personality using the personality root key; and
(e) maintaining an auditable data access log for the personality.

2. The method of claim 1, wherein the device comprises a computing device comprising a key management mechanism.

3. The method of claim 1, wherein the operating environment comprises one or more of: operating system version, firmware version, device ID, root ID, container ID, virtual machine ID, and session tokens.

4. The method of claim 1, further comprising generating a plurality of unique personalities for the device.

5. The method of claim 4, wherein the plurality of unique personalities comprises at least one split personality.

6. The method of claim 5, wherein the plurality of unique personalities comprises one or more adjacent personalities, lateral personalities, or hierarchical personalities.

7. The method of claim 1, wherein the data access matrix is stored in non-volatile random-access memory.

8. The method of claim 7, wherein the non-volatile random-access memory comprises one-time programmable memory.

9. The method of claim 1, wherein the data access log for the personality is tamperproof.

10. The method of claim 1, wherein the personality root key is derived at device boot.

11. The method of claim 10, further comprising deriving the personality root key each time the device is booted into the selected personality to access the subset of the data.

12. The method of claim 1, further comprising receiving a data access request from a requesting entity.

13. The method of claim 12, further comprising decrypting the requested data using the derived personality root key.

14. The method of claim 13, further comprising returning the requested data to the requesting entity.

15. The method of claim 1, wherein the personality root key is deleted when the device is powered off.

16. The method of claim 1, further comprising revoking the selected personality rendering the personality root key invalid.

17. The method of claim 1, wherein each auditable data access log comprises one or more of: requesting entity, requested data, device personality at time of request, date and time of request, device personality at the time of access, date of access, or time of access.

18. A computer-implemented system comprising at least one processor, non-volatile memory, volatile memory, and instructions executable by the at least one processor to cause the at least one processor to perform operations comprising:
(a) generating a unique personality for a device using parameters comprising one or more of: device lifecycle stage, device debug state, device ownership, device operating environment, and user credentials;
(b) maintaining a data access matrix associating the personality with a subset of data stored in the device;
(c) deriving a unique personality root key by cryptographically combining the personality with a physically unclonable function root key;
(d) encrypting the subset of the data associated with the personality using the personality root key; and
(e) maintaining an auditable data access log for the personality.

19. The system of claim 18, wherein the device comprises a computing device comprising a key management mechanism.

20. The system of claim 18, wherein the operating environment comprises one or more of: operating system version, firmware version, device ID, root ID, container ID, virtual machine ID, and session tokens.

21. The system of claim 18, further comprising generating a plurality of unique personalities for the device.

22. The system of claim 21, wherein the plurality of personalities comprises at least one split personality.

23. The system of claim 22, wherein the plurality of personalities comprises one or more adjacent personalities, lateral personalities, or hierarchical personalities.

24. The system of claim 18, wherein the data access matrix is stored in non-volatile random-access memory.

25. The system of claim 24, wherein the non-volatile random-access memory comprises one-time programmable memory.

26. The system of claim 18, wherein the data access log for the personality is tamperproof.

27. The system of claim 18, wherein the personality root key is derived at device boot.

28. The system of claim 27, further comprising deriving the personality root key each time the device is booted into the selected personality to access the subset of the data.

29. The system of claim 18, further comprising receiving a data access request from a requesting entity.

30. The system of claim 29, further comprising decrypting the requested data using the derived personality root key.

31. The system of claim 30, further comprising returning the requested data to the requesting entity.

32. The system of claim 18, wherein the personality root key is deleted when the device is powered off.

33. The system of claim 18, further comprising revoking the selected personality rendering the personality root key invalid.

34. One or more non-transitory computer-readable storage media encoded with instructions executable by one or more processors to provide an application configured to perform operations comprising:
(a) generating a unique personality for a device using parameters comprising one or more of: device lifecycle stage, device debug state, device ownership, device operating environment, and user credentials;
(b) maintaining a data access matrix associating the personality with a subset of data stored in the device;
(c) deriving a unique personality root key by cryptographically combining the personality with a physically unclonable function root key;
(d) encrypting the subset of the data associated with the personality using the personality root key; and
(e) maintaining an auditable data access log for the personality.
